(19) United States
(12) Patent Application Publication
(10) Pub. No.: US 2020/0272945 A1
(43) Pub. Date: Aug. 27, 2020

(54) SYSTEM AND METHOD OF DECENTRALIZED MODEL BUILDING FOR MACHINE LEARNING AND DATA PRIVACY PRESERVING USING BLOCKCHAIN

(71) Applicant: Hewlett Packard Enterprise Development LP, Houston, TX (US)

(72) Inventors: SATHYANARAYANAN MANAMOHAN, Chennai (IN); KRISHNAPRASAD LINGADAHALLI SHASTRY, Bangalore (IN); VISHESH GARG, Bangalore (IN); ENG LIM GOH, Singapore (SG)

(21) Appl. No.: 16/281,410

(22) Filed: Feb. 21, 2019

(51) Int. Cl. G06N 20/10; H04L 9/06; G06F 16/27

(52) U.S. Cl. CPC G06N 20/10; H04L 2209/38; G06F 16/27; H04L 9/0637

(57) ABSTRACT

Decentralized machine learning to build models is performed at nodes where local training datasets are generated. A blockchain platform may be used to coordinate decentralized machine learning over a series of iterations. For each iteration, a distributed ledger may be used to coordinate the nodes communicating via a blockchain network. A node can have a local training dataset that includes raw data, where the raw data is accessible locally at the computing node. Further, a node can train a local model based on the local training dataset during a first iteration of training a machine-learned model. The node can generate shared training parameters based on the local model in a manner that precludes any requirement for the raw data to be accessible by each of the other nodes on the blockchain network to perform the decentralized machine learning, while preserving privacy of the raw data.

### DESCRIPTION OF RELATED ART

Efficient model building requires large volumes of data. While distributed computing has been developed to coordinate large computing tasks using a plurality of computers, applications to large scale machine learning (“ML”) problems is difficult. There are several practical problems that arise in distributed model building such as coordination and deployment difficulties, security concerns, effects of system latency, fault tolerance, parameter size and others. While these and other problems may be handled within a single data center environment in which computers can be tightly controlled, moving model building outside of the data center into truly decentralized environments creates these and additional challenges, especially while operating in open networks. For example, in distributed computing environments, the accessibility of large and sometimes private training datasets across the distributed devices can be prohibitive and changes in topology and scale of the network over time makes coordination and real-time scaling difficult.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 depicts an example of a system of decentralized model building for machine learning (ML) and data privacy preserving using blockchain, according to some embodiments.

FIGS. 2A-2B illustrate an example of nodes in the system of decentralized model building shown in FIG. 1 communicating using parameter sharing techniques for data privacy preserving in ML, according to some embodiments.

FIG. 3 illustrates an example of a node configured for communicating using the parameter sharing techniques for data privacy preserving in ML shown in FIGS. 2A-2B, according to some embodiments.

FIG. 4 is an operational flow diagram illustrating an example of a process of an iteration of model building for ML and data privacy preserving using blockchain, according to some embodiments.

FIG. 5 is an operational flow diagram illustrating an example of a process performed by a participant node shown in FIG. 2A-2B for participating in decentralized model building for ML and data privacy preserving using blockchain, according to some embodiments.

FIG. 6 is an operational flow diagram illustrating an example of a process performed by a master node shown in FIG. 2A-2B for participating in decentralized model building for ML and data privacy preserving using blockchain, according to some embodiments.

FIG. 7 illustrates an example computer system that may be used in implementing decentralized model building for machine learning (ML) and data privacy preserving using blockchain relating to the embodiments of the disclosed technology.

The figures are not exhaustive and do not limit the present disclosure to the precise form disclosed.

### DETAILED DESCRIPTION

Various embodiments described herein are directed to a method and a system of decentralized model building for machine learning (ML) and data privacy preserving using blockchain. In many existing ML techniques, training of a model is accomplished using a training dataset that is common amongst all of the ML participants. That is, in order for some current ML techniques to operate with the expected precision, there is an implied requirement that all categories of data within the training dataset be fully visible to each of the ML participants (or to all of the nodes in a ML system). In this machine learning era, data is becoming a strategic asset of organizations. As such, in many cases, data needs to be retained, curated and federated. The need for data retention is based on the vast amounts of data often used to support robust machine learning approaches. Data curation can be related to a need to locate data and further manage assembling the data promptly for machine learning. Data may need to be federated for pan-organization usage, for example as it pertains to pan-enterprise operational data or to pan-IoT deployment data. Although full data accessibility may be advantageous for the concept of ML, there has been an increasing demand for maintaining the privacy of data in many real-world applications. For example, the misuse of personal identifiable information (PII) and corporate data in computing environments, as well as sophisticated data security attacks (e.g., hackers, malware, phishing, etc.) has bolstered the desirability of preserving the privacy of some types of information. Private data may be restricted such that the data is protected from unauthorized access, use, or inspection. In some cases, private data can be made inaccessible to unauthorized devices on a network, thereby preserving the privacy of data and mitigating vulnerabilities. Accordingly, data that is considered to be private can be siloed (e.g., remaining under the control of particular department, while being isolated from other areas of an organization) or protected by data security mechanisms, such as firewalls. Furthermore, these instances of siloed private data are seemingly more prevalent across a wide range of industries, for example in instances of federated data mentioned above. Acquiring access to such private data is becoming all the more complex due to legal and region-specific restrictions, which can involve elaborate data usage agreements (e.g., on a peer-to-peer basis).

The importance of maintaining data privacy may present challenges with respect to integrating many of the existing ML techniques into computer networked systems. As alluded to above, conventional ML systems depend heavily on the accessibility of the data between the nodes within the system. For example, a group of computers may be involved in a cooperative machine learning process. However, a subset of computers in the group participating in the process may be restricted from accessing private data via a network. Conversely, another subset of computers in the group participating in the can have access to the private data, thus using the private data in its training dataset during ML. Such instances where only a subset of the full training dataset is available to some computers in the ML process is referred to hereinafter as “biased data environments.” Applying conventional ML techniques in biased data environments can lead to problematic scenarios, such as nodes that fail to learn patterns that are missing in the biased dataset, but are present in the full training dataset. The decentralized model building techniques disclosed herein leverage features of blockchain to operate in biased data environments in a manner that preserves data privacy, without limiting the accuracy of the models and negatively impacting the effectiveness of the ML process.

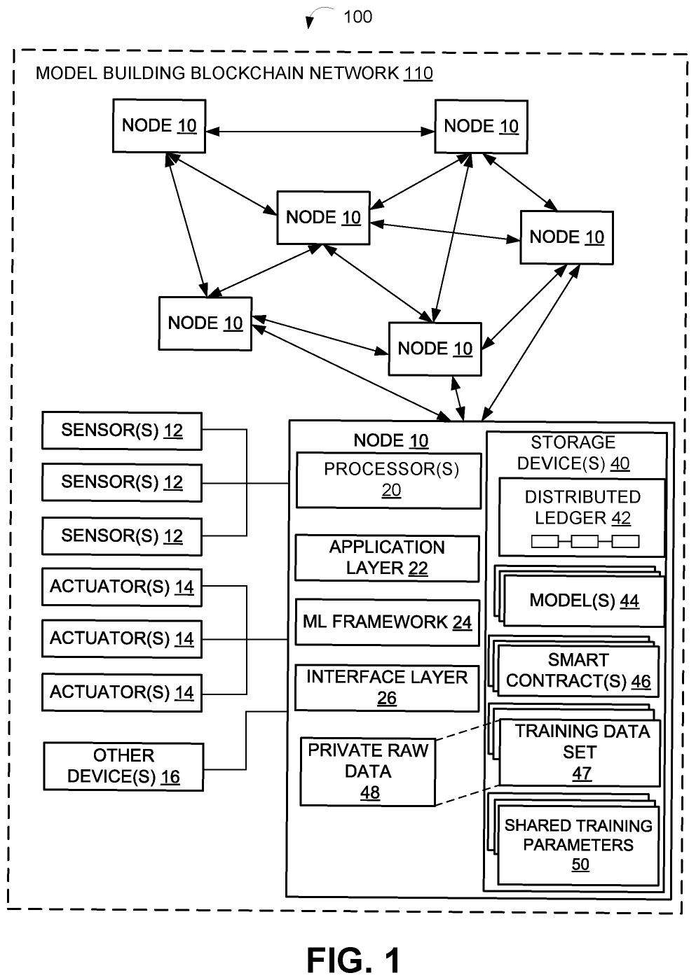

Referring to FIG. 1, an example of a system 100 of decentralized model building for machine learning (ML) and data privacy preserving using blockchain is shown. According to the embodiments, the system 100 performs decentralized parallel ML at nodes 10 over multiple iterations in a blockchain network 110. System 100 may include a model building blockchain network 110 (also referred to as a blockchain network 110) that includes a plurality of computing nodes, or computer devices. Generally, a blockchain network 110 can be a network where nodes 10 use a consensus mechanism to update a blockchain that is distributed across multiple parties. The particular number, configuration and connections between nodes 10 may vary. As such, the arrangement of nodes 10 shown in FIG. 1 is for illustrative purposes only. A node, such as node 10a may be a fixed or mobile device. Examples of further details of a node 10 will now be described. While only one of the nodes 10 is illustrated in detail in the figures, each of the nodes 10 may be configured in the manner illustrated.

Node 10 may include one or more sensors 12, one or more actuators 14, other devices 16, one or more processors 20 (also interchangeably referred to herein as processors 20, processor(s) 20, or processor 20 for convenience), one or more storage devices 40, and/or other components. The sensors 12, actuators 14, and/or other devices 16 may generate data that is accessible locally to the node 10. Such data may not be accessible to other participant nodes 10 in the model building blockchain network 110. Furthermore, according to various implementations, the node 10 and components described herein may be implemented in hardware and/or software that configure hardware.

FIG. 1 shows that the storage device(s) 40 may store: distributed ledger 42, model(s) 44, and smart contract(s) 46, and training dataset 47. The distributed ledger 42 may include a series of blocks of data that reference at least another block, such as a previous block. In this manner, the blocks of data may be chained together. The distributed ledger 42 may store blocks that indicate a state of a node 10 relating to its machine learning during an iteration. Thus, the distributed ledger 42 may store an immutable record of the state transitions of a node 10. In this manner, the distributed ledger 42 may store a current and historic state of a model 44. It should be noted, however, that in some embodiments, some collection of records, models, and smart contracts from one or more of other nodes (e.g., node(s) 10b-10g) may be stored in distributed ledger 42.

The distributed ledger 42, transaction queue, models 44, smart contracts 46, shared training parameters 50, merged parameters, local training datasets, and/or other information described herein may be stored in various storage devices such as storage device 40. Other storage may be used as well, depending on the particular storage and retrieval requirements. For example, the various information described herein may be stored using one or more databases. Other databases, such as Informix™, DB2 (Database 2) or other data storage, including file-based, or query formats, platforms, or resources such as OLAP (On Line Analytical Processing), SQL (Structured Query Language), a SAN (storage area network), or others may also be used, incorporated, or accessed. The database may comprise one or more such databases that reside in one or more physical devices and in one or more physical locations. The database may store a plurality of types of data and/or files and associated data or file descriptions, administrative information, or any other data.

As shown in FIG. 1, the node 10 can store a training dataset 47 locally in storage device(s) 40. FIG. 1 also illustrates that at least a portion of the training dataset 47 can include private raw data 48. Private raw data 48 can be the actual data that is processed in building a model. In contrast, shared training parameters 50 can be the internal parameters/variables for the ML model resulting from training using the raw data. In some cases, private raw data 48 may be considered private data, such that the access to private raw data 48 external to node 10 may be restricted. Node 10 may be configured to protect private raw data 48, in cases when the raw data includes private data. For example, node 10 can implement a security mechanism (e.g., firewall, anti-virus software, intrusion detection and prevention system) that blocks remote access to private raw data 48 by an unauthorized node 10 via the blockchain network 110. As another example, node 10 can implement a security mechanism that prevents private raw data 48 from being intelligible to an unauthorized node 10, such as encryption.

According to the parameter sharing aspects of the embodiments, other nodes 10 on the blockchain network 110 are not required to have awareness of the private raw data 48 during the model building process. Many existing ML approaches would a require node to transmit a full training dataset to a central location, where the model is built. However, this central approach requires transmitting all of the raw data of the training dataset, even any private data that may be inaccessible to the remaining nodes or would result in compromising the privacy if accessed. Consequently, in a biased data environment, it is conceivable that each of the nodes 10 in the blockchain network 110 may not have permission to access and/or employ the entire training dataset 47 (e.g., including private data), thus impacting the precision of the model. However, in accordance with the parameter sharing techniques, node 10 is programmed to communicate the shared training parameters 50, as opposed to the private raw data 48. The embodiments allow the learning done by node 10 during the building of its local model, which is based on the private raw data 48, to be communicated vis-à-vis the shared training parameters 50. Consequently, parameter sharing aspects can preserve the privacy of private raw data 48. Although private raw data 48 it not transmitted or otherwise accessed (in a manner that potentially compromises privacy), other nodes 10 in the blockchain network 110 can build models from patterns learned based on the private raw data 48. Accordingly, the embodiments privacy preserving, while implementing sharing in a manner that prevents the loss of any training in the presence of biased data (e.g., due to privacy concerns).

Model 44 may be locally trained at a node 10 based on locally accessible data such as the training dataset 47, as described herein. The model 44 can then be updated based on model parameters learned at other participant nodes 10 that are shared via the blockchain network 110, according to the parameter sharing aspects of the embodiments. The nature of the model 44 can be based on the particular implementation of the node 10 itself. For instance, model 44 may include trained parameters relating: to self-driving vehicle features such as sensor information as it relates object detection, dryer appliance relating to drying times and controls, network configuration features for network configurations, security features relating to network security such as intrusion detection, and/or other context-based models.

The smart contracts 46 may include rules that configure nodes 10 to behave in certain ways in relation to decentralized machine learning. For example, the rules may specify deterministic state transitions, when and how to elect a master node, when to initiate an iteration of machine learning, whether to permit a node to enroll in an iteration, a number of nodes required to agree to a consensus decision, a percentage of voting nodes required to agree to a consensus decision, and/or other actions that a node 10 may take for decentralized machine learning.

Processors 20 may be programmed by one or more computer program instructions. For example, processors 20 may be programmed to execute an application layer 22, a machine learning framework 24 (illustrated and also referred to as ML framework 24), an interface layer 26, and/or other instructions to perform various operations, each of which are described in greater detail herein. The processors 20 may obtain other data accessible locally to node 10 but not necessarily accessible to other participant nodes 10 as well. Such locally accessible data may include, for example, private data that should not be shared with other devices. As disclosed herein, model parameters that are learned from the private data can be shared according to parameter sharing aspects of the embodiments.

The application layer 22 may execute applications on the node 10. For instance, the application layer 22 may include a blockchain agent (not illustrated) that programs the node 10 to participate and/or serve as a master node in decentralized machine learning across the blockchain network 110 as described herein. Each node 10 may be programmed with the same blockchain agent, thereby ensuring that each node acts according to the same set of decentralized model building rules, such as those encoded using smart contracts 46. For example, the blockchain agent may program each node 10 to act as a participant node as well as a master node (if elected to serve that roll). The application layer 22 may execute machine learning through the ML framework 24.

The ML framework 24 may train a model based on data accessible locally at a node 10. For example, the ML framework 24 may generate model parameters from data from the sensors 12, the actuators 14, and/or other devices or data sources to which the node 10 has access. In an implementation, the ML framework 24 may use a machine learning framework, although other frameworks may be used as well. In some of these implementations, a third-party framework Application Programming Interface (“API”) may be used to access certain model building functions provided by the machine learning framework. For example, a node 10 may execute API calls to a machine learning framework (e.g., TensorFlown™).

The application layer 22 may use the interface layer 26 to interact with and participate in the blockchain network 110 for decentralized machine learning across multiple participant nodes 10. The interface layer 26 may communicate with other nodes using blockchain by, for example, broadcasting blockchain transactions and, for a master node elected as describe herein elsewhere, writing blocks to the distributed ledger 42 based on those transactions as well as based on the activities of the master node.

Model building for ML may be pushed to the multiple nodes 10 in a decentralized manner, addressing changes to input data patterns, scaling the system, and coordinating the model building activities across the nodes 10. Moving the model building closer to where the data is generated or otherwise is accessible, namely at the nodes 10, can achieve efficient real time analysis of data at the location where the data is generated, instead of having to consolidate the data at datacenters and the associated problems of doing so. Without the need to consolidate all input data into one physical location (data center or “core” of the IT infrastructure), the disclosed systems, methods, and non-transitory machine-readable storage media may reduce the time (e.g., model training time) for the model to adapt to changes in environmental conditions and make more accurate predictions. Thus, applications of the system may become truly autonomous and decentralized, whether in an autonomous vehicle context and implementation or other loT or network-connected contexts.

According to various embodiments, decentralized ML can be accomplished via a plurality of iterations of training that is coordinated between a number of computer nodes 10. In accordance with the embodiments, ML is facilitated using a distributed ledger of a blockchain network 110. Each of the nodes 10 can enroll with the blockchain network 110 to participate in a first iteration of training a machine-learned model at a first time. Each node 10 may participate in a consensus decision to enroll another computing node 10 to participate in the first iteration. The consensus decision can apply only to the first iteration and may not register the second physical computing node to participate in subsequent iterations.

In some cases, a specified number of nodes 10 are required to be registered for an iteration of training. Thereafter, each node 10 may obtain a local training dataset 47 accessible locally but not accessible at other computing nodes 10 in the blockchain network. The node 10 may train a first local model 44 based on the local training dataset 47 during the first iteration and obtain at least a first shared training parameter 50 based on the first local model. Similarly, each of the other nodes 10 on the blockchain network 100 can train a local model, respectively. In this manner, node 10 may train on private raw data 48 that is locally accessible but should not (or cannot) be shared with other nodes 10, as discussed in further detail below. Node 10 can generate a blockchain transaction comprising an indication that it is ready to share the shared training parameters 50 and may transmit or otherwise provide the shared training parameters 50 to a master node. The node 10 may do so by generating a blockchain transaction that includes the indication and information indicating where the training parameters may be obtained (such as a Uniform Resource Indicator address). When some or all of the participant nodes are ready to share its respective training parameters, a master node (also referred to as “master computing node”) may write the indications to a distributed ledger. The minimum number of participants nodes that are ready to share training parameters in order for the master node to write the indications may be defined by one or more rules, which may be encoded in a smart contract, as described herein.

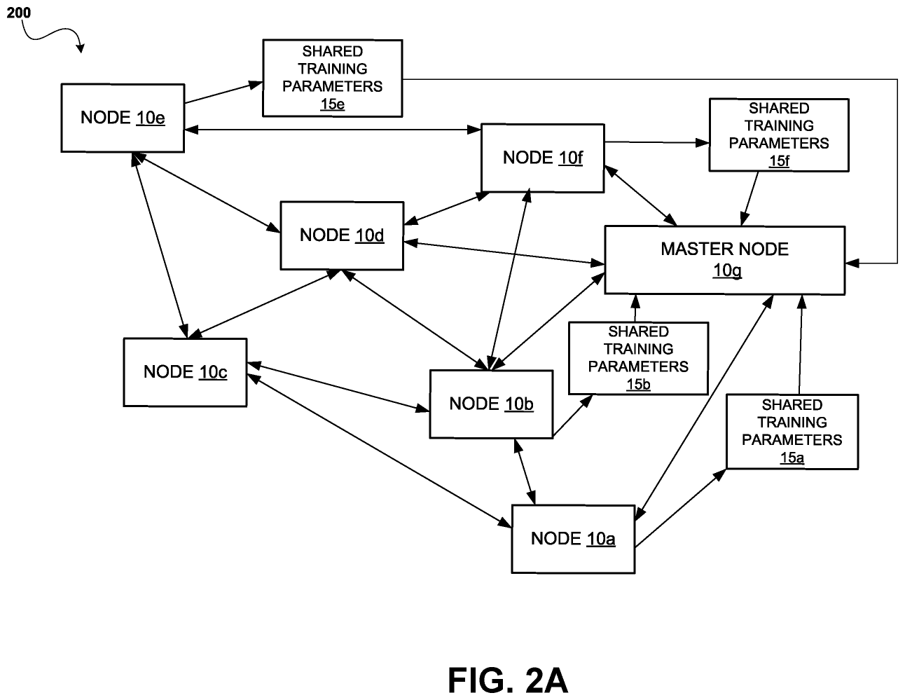

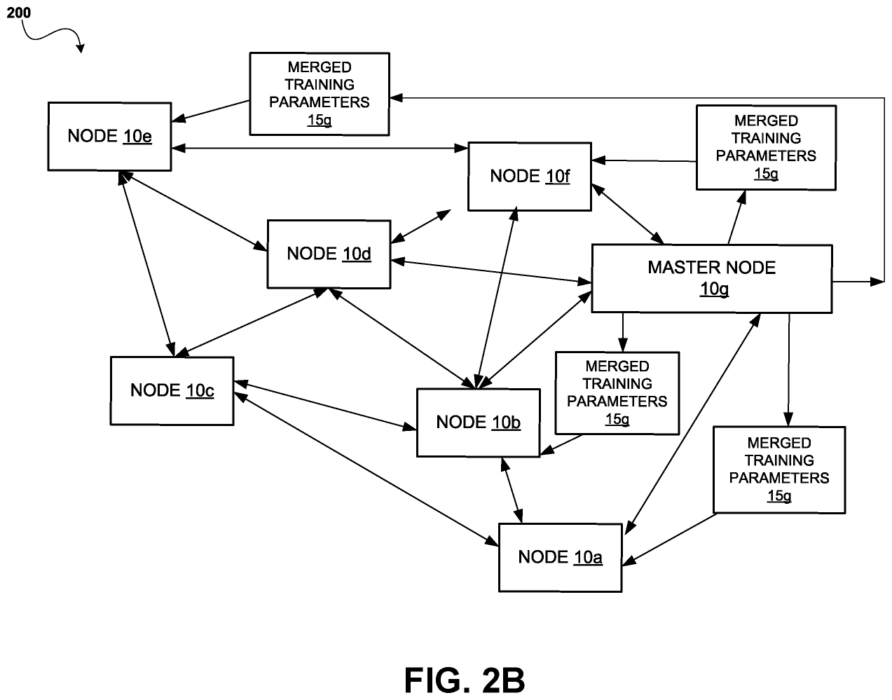

FIGS. 2A-2B show an example of nodes 10a-10g in a system of decentralized model building communicating using the parameter sharing techniques described above. FIG. 2A-2B illustrates an example of an iteration of model building (also referred to herein as machine learning or model training). The iteration is illustrated as including multiple phases, such as a first phase (primarily shown in FIG. 2A) and second phase (primarily shown in FIG. 2B). In reference to FIG. 2A, the first phase can include the participant nodes 10a-10f training its local models independently of the other participant nodes using its local training dataset. As described above, a training data set may be accessible locally to the participant node but not to other nodes. As such, each participant node 10a-10f may generate model parameters resulting from the local training dataset, referred to herein as shared parameters. The example of FIG. 2A particularly illustrates shared training parameters 15a, 15b, 15e, and 15f. As a result, the participant nodes 10a-10f may each share their respective model parameters, as shared parameters, with other participants in the blockchain network. For example, each participant node 10a-10f may communicate its shared parameter to a master node 10g, which is elected from among the nodes in the blockchain network. Now referring to FIG. 2B, the second phase may involve the master node 10g receiving and combining the shared parameters from the participant nodes 10a-10f, in order to generate merged training parameters 15g for the current iteration. The merged training parameters 15g may be distributed to the participant nodes 10a-10f, which each update their local state.

As seen in FIG. 2A, the master node 10g can be included in the blockchain network 200. The master node 10g may generate a new transaction to be added as a ledger block to each copy of the distributed ledger based on the indication that one of the computing nodes 10a-10f is ready to share its shared training parameter, for example. The master node 10g may be elected from among the other nodes 10a-10f by consensus decision or may simply be selected based on being the first node to enroll in the iteration. Each of the other nodes enrolled to participate in an iteration are referred to herein as a “participant node.” FIG. 2A illustrates nodes 10a-10f as the participant nodes in the blockchain network 200. According to the embodiments, participant nodes 10a-10f can train a local model using training data that is accessible locally at the node, but may not be accessible at other nodes, as alluded to above. For example, the training data may include sensitive or otherwise private data that should not be shared with other nodes. However, training parameters learned from such data through machine learning can be shared, as the training parameters typically do not expose raw data (which may be comprised of sensitive information) and thus are not subject to privacy restrictions. When the training parameters are determined by a node, the node may broadcast an indication that it is ready to share the training parameters. For example, participant node 10a, after training its local model using training data, can broadcast an indication via the blockchain network 200, which is received at least by the master node 10g. Subsequently, participant node 10a can communicate its shared training data 15a via the blockchain network 200, which is received by the master node 10g. FIG. 2A illustrates shared training parameters 15a, 15b, 15e, and 15f. As a general description, a master node 10g may obtain shared training parameters from each of the participant nodes 10a-10f in the blockchain network 200, referred to herein as “parameter sharing.”

In the illustrated example of FIG. 2A, nodes 10a, 10b, 10e, and 10f are illustrated as communicating shared training parameters 15a, 15b, 15e, and 15f, respectively to the master node 10g. It should be appreciated that each of the nodes 10a-10f in the blockchain network 200 are capable of communicating shared training parameters to the master node 10g, although not explicitly shown in FIG. 2A. In some cases, parameters which comprise the shared training parameters 15a, 15b, 15e, and 15f are floating point numbers that are generated in relation to training a model. For instance, shared training parameters 15a can be generated as a result of a first iteration of training using a training dataset, including raw data, that is locally available at node 10a. Similarly, shared training parameters 15b can be generated as a result of a first iteration of training using a training dataset that is locally available at node 10b, and so on. Thus, the parameter sharing aspects, as disclosed, can generally be described as a node sharing the learning that is based on its local raw data, as opposed to the sharing the raw data itself.

Furthermore, shared training parameters 15a, 15b, 15e, and 15f may be a substantially reduced amount of data as compared to entire models or the entire training dataset. Accordingly, implementing parameter sharing can realize advantages associated with communicating less data, over some approaches that may address privacy preserving concerns by sharing larger data structures, such as the models, to multiple nodes across the network. For example, parameter sharing techniques may reduce network bandwidth consumption, avoid congestion, and improve overall efficiency of the ML process. Additionally, parameter sharing can be more burst-oriented, having low data rate flows that may be particularly suited for low power transmissions.

As discussed above, training data can include private data that should not be shared with other nodes. Thus, there are instances where it may be desirable to protect private data within the blockchain network 200 during the ML process. As an example, a portion of the training dataset corresponding to node 10a may be subject to privacy restrictions, which can prevent that data from being externally accessible to the other participant nodes 10b-10f on the blockchain network 200. As such, ML occurring on the system shown in FIG. 2A is within a biased data environment (only a subset of the full training dataset is available). Nonetheless, the embodiments use an approach that modifies the type of data that is shared during decentralized ML, which continues to protect any private data. In contrast, some existing ML techniques address privacy concerns by modifying how the data is shared, in order to achieve ML. For instance, some current ML systems may be adapted to include secure communication mechanisms, such as encrypted links, as an attempt to maintain privacy during the transmission of private data. For instance, some traditional ML techniques may communicate the full training dataset, including any private data that is used for training models, in a secure manner to a centralized location, where the models are subsequently built. Nonetheless, the disclosed parameter sharing techniques mitigate the need for establishing secure communication and/or channels, as private data is not shared, only data that is public (suggesting that the data can be communicated using insecure communication and/or channels).

Referring back to the example in FIG. 2A, node 10a can contribute its shared training parameters 15a to the decentralized ML process, thereby eliminating the need for node 10a to communicate its private data to other nodes 10b-10f as part of a full training dataset (in a manner that may violate any privacy restrictions). Thus, the embodiments can realize advantages associated with preventing a requirement for secure transmission, such as lower operating costs, higher speeds, faster deployments, and greater bandwidth capabilities. It should be appreciated that not all of the nodes in the blockchain network 200 may enroll to participate in an iteration of model training. However, all nodes may obtain the merged training parameters, or updated training parameter, from the iteration. Nodes enrolled to participate in an iteration of model training may collectively generate a consensus decision on whether to enroll a node based on a requesting node's state and/or credentials.

Upon generation of the merged training parameters (shown in FIG. 2B), the master node 10g may broadcast an indication to the blockchain network 200 that the merged training parameters are available. The master node 10g may broadcast the indication that it has completed generating the merged training parameters 15g, by writing a blockchain transaction that indicates the state change. Such state change (in the form of a transaction) may be recorded as a block to the distributed ledger with such indication. The participating nodes 10a-10f may periodically monitor the distributed ledger to determine whether the master node 10g has completed the merge, and if so, obtain the merged training parameters 15g. Each of the nodes may then apply the merged training parameters to its local model and then update its state, which is written to the distributed ledger. The master node 10g generating the merged training parameters can involve the master node 10g averaging all of the received shared training parameters from participating nodes. Referring to FIG. 2A, the master node 10g can extract values corresponding to the shared training parameters 15a, 15b, 15e, and 15f and calculate an average of those values, in order to further determine a collective pattern from the individual training parameters. The calculated average can act as a merging of the shared training parameters 15a, 15b, 15f, and 15g, which is further used to generate the merged training parameters. It should be understood that merging the shared training parameters can be accomplished in a variety of ways by the mater node 10g, including: by consensus; by majority decision; averaging; and/or other mechanism(s) or algorithms. For example, Gaussian merging-splitting can be performed. As another example, cross-validation across larger/smaller groups of training parameters can be performed vis-a-vis radial basis function kernel, where the kernel can be a measure of similarity between training parameters. As such, the master node 10g aggregates the individual learning done at each of the respective nodes 10a, 10b, 10e, and 10f during decentralized model building, and distributes the shared learning back to the participating nodes 10a-10e.

In FIG. 2B, an example of the blockchain network 200 is shown, illustrating the participating nodes 10-10g communicating in accordance with the disclosed parameter sharing aspects. In general, FIG. 2B shows communication of data in the blockchain network 200 that occurs subsequent to that seen in FIG. 2A. Referring to FIG. 2B, participant nodes 10a- 10f may obtain, from the blockchain network 200, one or more merged training parameters 15g that were generated by the master node 10g based on the received shared training parameters (shown in FIG. 2B). It should be appreciated that the master node 10g is capable of distributing the merged training parameters to each of the nodes 10a-10f in the blockchain network 200, although not explicitly shown in FIG. 2A. Each participant node 10a-10f may then apply the one or more merged training parameters 15g to update its local model using the learning that is shared via the parameters. In the illustrated example, master node 10e transmits the merged training parameters 15g to each of the participating nodes 10a, 10b, 10e, 10f. As previously described, the merged training parameters 15g may be an average of each of the received shared training parameters, thus signifying a combination of the learning occurring at each of the participating nodes 10a, 10b, 10e, and 10f while the distributed models are being built. Accordingly, in continuing with the example, the participating node 10a learns features from training performed by participating nodes 10b, 10e, and 10f via the merged training parameters 15e. Similarly, the participating node 10b learns features from training performed by the participating nodes 10a, 10e, 10f via the merged training parameters 15e, and so on. In some cases, after the master node 10g has completed the merge, the master node 10g also releases its status as master node for the iteration. In the next iteration a new master node will likely, though not necessarily, be selected. Training may iterate until the training parameters converge. Training iterations may be restarted once the training parameters no longer converge, thereby continuously improving the model as needed through the blockchain network. It should be appreciated that even nodes that did not participate in the current iteration may consult the distributed ledger to synchronize to the latest set of training parameters. In this manner, decentralized machine learning may be dynamically scaled as the availability of nodes changes, while providing updated training parameters learned through decentralized machine learning to nodes as they become available or join the network.

Each node enrolled to participate in an iteration (also referred to herein as a “participant node”) may train a local model using training data that is accessible locally at the node but may not be accessible at other nodes. For example, the training data may include sensitive or otherwise private information that should not be shared with other nodes, but training parameters learned from such data through machine learning can be shared. When training parameters are obtained at a node, the node may broadcast an indication that it is ready to share the training parameters. The node may do so by generating a blockchain transaction that includes the indication and information indicating where the training parameters may be obtained (such as a Uniform Resource Indicator address). When some or all of the participant nodes are ready to share its respective training parameters, a master node (also referred to as “master computing node”) may write the indications to a distributed ledger. The minimum number of participants nodes that are ready to share training parameters in order for the master node to write the indications may be defined by one or more rules, which may be encoded in a smart contract, as described herein.

For example, the first node to enroll in the iteration may be selected to serve as the master node or the master node may be elected by consensus decision. The master node may obtain the training parameters from each of the participating nodes and then merge them to generate a set of merged training parameters. Merging the training parameters can be accomplished in a variety of ways, e.g., by consensus, by majority decision, averaging, and/or other mechanism(s) or algorithms. For example, Gaussian merging-splitting can be performed. As another example, cross-validation across larger/smaller groups of training parameters can be performed vis-a-vis radial basis function kernel, where the kernel can be a measure of similarity between training parameters. The master node may broadcast an indication that it has completed generating the merged training parameters, such as by writing a blockchain transaction that indicates the state change. Such state change (in the form of a transaction) may be recorded as a block to the distributed ledger with such indication. The nodes may periodically monitor the distributed ledger to determine whether the master node has completed the merge, and if so, obtain the merged training parameters. Each of the nodes may then apply the merged training parameters to its local model and then update its state, which is written to the distributed ledger.

By indicating that it has completed the merge, the master node also releases its status as master node for the iteration. In the next iteration a new master node will likely, though not necessarily, be selected. Training may iterate until the training parameters converge. Training iterations may be restarted once the training parameters no longer converge, thereby continuously improving the model as needed through the blockchain network.

Because decentralized machine learning as described herein occurs over a plurality of iterations and different sets of nodes may enroll to participate in any one or more iterations, decentralized model building activity can be dynamically scaled as the availability of nodes changes. For instance, even as autonomous vehicle computers go online (such as being in operation) or offline (such as having vehicle engine ignitions turned off), the system may continuously execute iterations of machine learning at available nodes. Using a distributed ledger, as vehicles come online, they may receive an updated version of the distributed ledger, such as from peer vehicles, and obtain the latest parameters that were learned when the vehicle was offline.

Furthermore, dynamic scaling does not cause degradation of model accuracy. By using a distributed ledger to coordinate activity and smart contracts to enforce synchronization by not permitting stale or otherwise uninitialized nodes from participating in an iteration, the stale gradients problem can be avoided. Use of the decentralized ledger and smart contracts may also make the system fault-tolerant. Node restarts and other downtimes can be handled seamlessly without loss of model accuracy by dynamically scaling participant nodes and synchronizing learned parameters. Moreover, building applications that implement the ML models for experimentation can be simplified because a decentralized application can be agnostic to network topology and role of a node in the system.

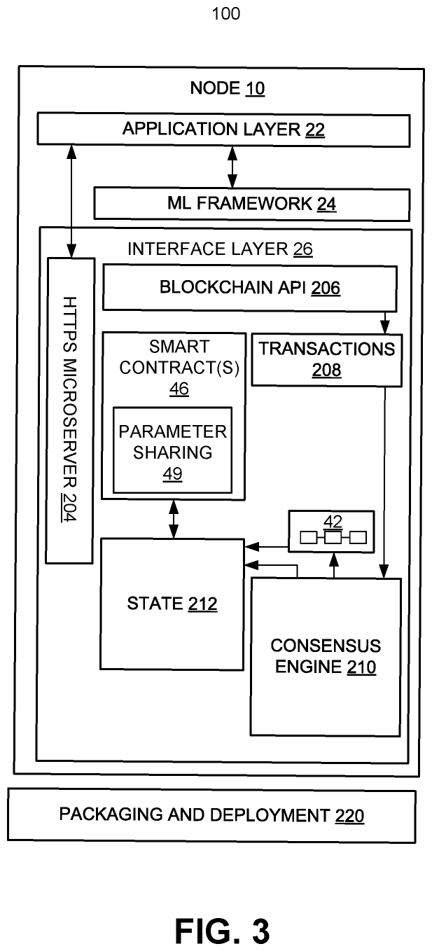

Referring now to FIG. 3, a schematic diagram of a node 10 that is configured for participating in an iteration of machine learning using blockchain is illustrated. FIG. 3 shows an example configuration of the node 10 which includes a parameter sharing module 49 for implementing the parameter sharing aspects disclosed herein. In the illustrated example, the parameter sharing module 49 can be a modular portion of the rules realized by smart contracts 46. As described above, smart contracts 46 may include rules that configure the node 10 to behave in certain ways in relation to decentralized machine learning. In particular, rules encoded by the parameter sharing module 49 can program node 10 to perform parameter sharing in a manner that preserves data privacy, as previously described. For example, the smart contacts 46 can cause node 10 to use the application layer 22 and the distributed ledger 42 to coordinate parallel model building during an iteration with other participant nodes. The application layer 22 may include a blockchain agent that initiates model training. Even further, the smart contracts 46, in accordance with the particular rules of the parameter sharing module 49, can configure the node 10 to communicate the shared parameters (as opposed to raw data). Thus, the parameter sharing module 49 includes rules that allow node 10 to share the learning gleaned from training its local model with a master node, and consequently with the other participant nodes during the iteration (shown in FIGS. 2A-2B), without exposing any private data that may be local to node 10 to the network.

The interface layer 26 may include a messaging interface used for the node 10 to communicate via a network with other participant nodes. As an example, the interface layer 26 provides the interface that allows node 10 to communicate its shared parameters (shown in FIG. 2B) to the other participating nodes during ML. The messaging interface may be configured as a Secure Hypertext Transmission Protocol (“HTTPS”) microserver 204. Other types of messaging interfaces may be used as well. The interface layer 26 may use a blockchain API 206 to make API calls for blockchain functions based on a blockchain specification. Examples of blockchain functions include, but are not limited to, reading and writing blockchain transactions 208 and reading and writing blockchain blocks to the distributed ledger 42. One example of a blockchain specification is the Ethereum specification. Other blockchain specifications may be used as well.

Consensus engine 210 may include functions that facilitate the writing of data to the distributed ledger 42. For example, in some instances when node 10 operates as a master node (e.g., one of the participant nodes 10), the node 10 may use the consensus engine 210 to decide when to merge the shared parameters from the respective nodes, write an indication that its state 212 has changed as a result of merging shared parameters to the distributed ledger 42, and/or to perform other actions. In some instances, as a participant node (whether a master node or not), node 10 may use the consensus engine 210 to perform consensus decisioning such as whether to enroll a node to participate in an iteration of machine learning. In this way, a consensus regarding certain decisions can be reached after data is written to distributed ledger 42.

In some implementations, packaging and deployment 220 may package and deploy a model 44 as a containerized object. For example, and without limitation, packaging and deployment 220 may use the Docker platform to generate Docker files that include the model 44. Other containerization platforms may be used as well. In this manner various applications at node 10 may access and use the model 44 in a platform-independent manner. As such, the models may not only be built based on collective parameters from nodes in a blockchain network, but also be packaged and deployed in diverse environments.

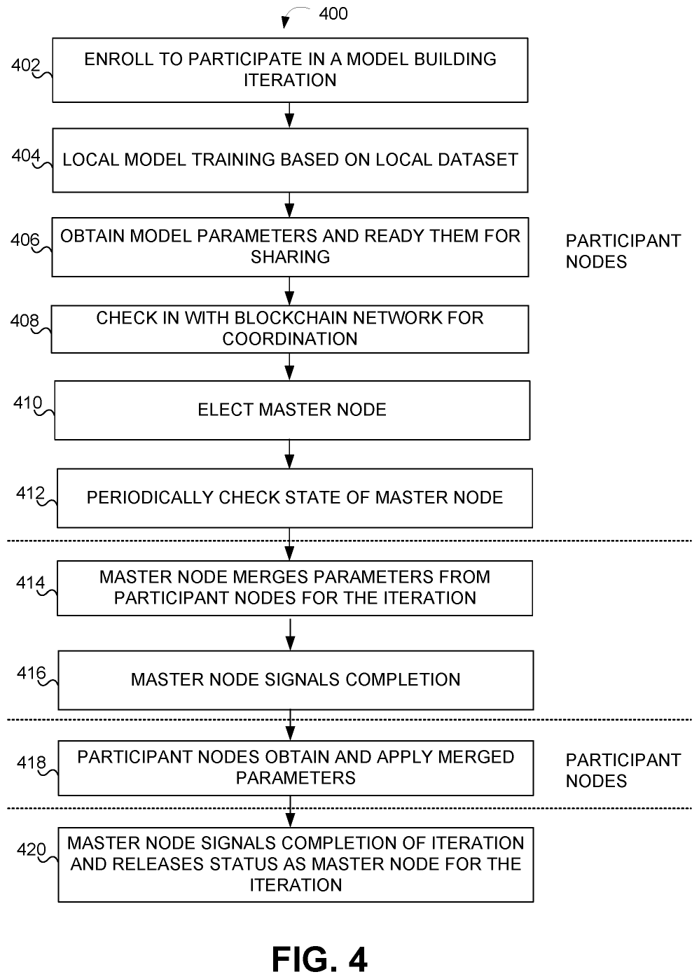

Further details of an iteration of model-building are now described with reference to FIG. 4, which illustrates an example of a process 400 of an iteration of model building using blockchain according to one embodiment of the systems and methods described herein. As illustrated in FIG. 4, operations 402-412 and 418 are applicable to participant nodes, whereas operations 414, 416, and 420 are applicable to master node.

In an operation 402, each participant node may enroll to participate in an iteration of model building. In an implementation, the smart contracts (shown in FIG. 3) may encode rules for enrolling a node for participation in an iteration of model building. The rules may specify required credentials, valid state information, and/or other enrollment prerequisites. The required credentials may impose permissions on which nodes are allowed to participate in an iteration of model building. In these examples, the blockchain network may be configured as a private blockchain where only authorized nodes are permitted to participate in an iteration.

The authorization information and expected credentials may be encoded within the smart contracts or other stored information available to nodes on the blockchain network. The valid state information may prohibit nodes exhibiting certain restricted semantic states from participating in an iteration. The restricted semantic states may include, for example, having uninitialized parameter values, being a new node requesting enrollment in an iteration after the iteration has started (with other participant nodes in the blockchain network), a stale node or restarting node, and/or other states that would taint or otherwise disrupt an iteration of model building. Stale or restarting nodes may be placed on hold for an iteration so that they can synchronize their local parameters to the latest values, such as after the iteration has completed.

Once a participant node has been enrolled, the blockchain network may record an identity of the participant node so that an identification of all participant nodes for an iteration is known. Such recordation may be made via an entry in the distributed ledger. The identity of the participant nodes may be used by the consensus engine (shown in FIG. 3) when making strategic decisions.

The foregoing enrollment features may make model building activity fault tolerant because the topology of the model building network (i.e., the blockchain network) is decided at the iteration level. This permits deployment in real world environments like autonomous vehicles where the shape and size of the network can vary dynamically.

In an operation 404, each of the participant nodes may execute local model training on its local training dataset. For example, the application layer (shown in FIG. 3) may interface with the machine learning framework (shown in FIG. 3) to locally train a model on its local training dataset. In accordance with the privacy preserving aspects of the embodiments, operation 404 can involve a biased data environment as a result of privacy restrictions. Accordingly, during operation 404, the full data set used for locally training a model at a node may include some private data, thus causing the full data set to be not be accessible at other participant nodes without compromising its privacy. The disclosed parameter sharing techniques enable privacy of data to be preserved during the collaborative model-building process 400.

In an operation 406, each of the participant nodes may generate local parameters based on the local training and may keep them ready for sharing with the blockchain network to implement parameter sharing. For example, after the local training cycle is complete, the local parameters may be serialized into compact packages that can be shared with rest of the blockchain network, in a manner similar to the shared parameters illustrated in FIG. 2A. Such sharing may be facilitated through making the shared parameters available for download and/or actively uploading them through peer-to-peer or other data transmission protocols. In some embodiments, the smart contracts may encode rules for a node to communicate, or otherwise share, its shared parameters.

In an operation 408, each participant node may check in with the blockchain network for co-ordination. For instance, each participant node may signal the other participant nodes in the blockchain network that it is ready for sharing its shared parameters. In particular, each participant node may write a blockchain transaction using, for example, the blockchain API (shown in FIG. 3) and broadcast the blockchain transaction via the messaging interface and the blockchain API. Such blockchain transactions may indicate the participant node's state (e.g., that it is ready to share its local parameters), a mechanism for obtaining the shared parameters, a location at which to obtain the shared parameters, and/or other information that conveys the readiness of a node for sharing or identification of how to obtain the shared parameters from other participant nodes. The transactions may be queued in a transaction queue or pool from which transactions are selected. These transactions may be timestamped and selected from, in some examples, in a first-in-first-out (“FIFO”) manner.

In an operation 410, participant nodes may collectively elect a master node for the iteration. For example, the smart contracts may encode rules for electing the master node. Such rules may dictate how a participant node should vote on electing a master node (for implementations in which nodes vote to elect a master node). These rules may specify that a certain number and/or percentage of participant nodes should be ready to share its shared parameters before a master node should be elected, thereby initiating the sharing phase of the iteration. It should be noted, however, that election of a master node may occur before participant nodes 10 are ready to share their shared parameters. For example, a first node to enroll in an iteration may be selected as the master node. As such, election (or selection) of a master node per se may not trigger transition to the sharing phase. Rather, the rules of smart contracts may specify when the sharing phase, referred to as phase 1 in reference to FIG. 2A, should be initiated, thereby ensuring this transition occurs in a deterministic manner.

The master node may be elected in various ways other than or in addition to the first node to enroll. For example, a particular node may be predefined as being a master node. When an iteration is initiated, the particular node may become the master node. In some of these instances, one or more backup nodes may be predefined to serve as a master node in case the particular node is unavailable for a given iteration. In other examples, a node may declare that it should not be the master node. This may be advantageous in heterogeneous computational environments in which nodes have different computational capabilities. One example is in a drone network in which a drone may declare it should be not the master node and a command center may be declared as the master node. In yet other examples, a voting mechanism may be used to elect the master node. Such voting may be governed by rules encoded in a smart contract. This may be advantageous in homogeneous computational environments in which nodes have similar computational capabilities such as in a network of autonomous vehicles. Other ways to elect a master node may be used according to particular needs and based on the disclosure herein.

In an operation 412, participant nodes that are not a master node may periodically check the state of the master node to monitor whether the master node has completed generation of the merged parameters based on the shared parameters that have been locally generated by the participant nodes. For example, each participant node may inspect its local copy of the distributed ledger, within which the master node will record its state for the iteration on one or more blocks.

In an operation 414, the master node may enter a sharing phase in which some or all participant nodes are ready to share their shared parameters. For instance, the master node may obtain shared parameters from participant nodes whose state indicated that they are ready for sharing. Using the blockchain API, the master node may identify transactions that both: (1) indicate that a participant node is ready to share its shared parameters and (2) are not signaled in the distributed ledger. In some instances, transactions in the transaction queue have not yet been written to the distributed ledger. Once written to the ledger, the master node (through the blockchain API) may remove the transaction from or otherwise mark the transaction as confirmed in the transaction queue. The master node may identify corresponding participant nodes that submitted them and obtain the shared parameters (the location of which may be encoded in the transaction). The master node may combine the shared parameters from the participant nodes to generate merged parameters (shown in FIG. 2B) for the iteration based on the combined shared parameters. It should be noted that the master node may have itself generated local parameters from its local training dataset, in which case it may combine its local parameters with the obtained shared parameters as well. Consequently, the master node can combine all of the individual learning from each of the participant nodes across the blockchain network during the distributed process. For example, operation 414 can be described as compiling the learned patterns from training local model at each of the participant node using by merging the shared parameters. As alluded to above, at operation 414, the master node can use shared parameters from training the models, rather than the raw data used to build the models to aggregate the distributed learning in manner that preserves data privacy. In an implementation, the master node may write the transactions as a block on the distributed ledger, for example using blockchain API.

In an operation 416, the master node may signal completion of the combination. For instance, the master node may transmit a blockchain transaction indicating its state (that it combined the local parameters into the final parameters). The blockchain transaction may also indicate where and/or how to obtain the merged parameters for the iteration. In some instances, the blockchain transaction may be written to the distributed ledger.

In an operation 418, each participant node may obtain and apply the merged parameters on their local models. For example, a participant node may inspect its local copy of the distributed ledger to determine that the state of the master node indicates that the merged parameters are available. The participant node may then obtain the merged parameters. It should be appreciated that the participant nodes are capable of obtaining, and subsequently applying, the combined learning associated with the merged parameters (resulting from local models) such that it precludes the need to transmit and/or receive full training datasets (corresponding to each of the local model). Furthermore, any private data that is local to a participant node and may be part of its full training dataset can remain protected.

In an operation 420, the master node may signal completion of an iteration and may relinquish control as master node for the iteration. Such indication may be encoded in the distributed ledger for other participant nodes to detect and transition into the next state (which may be either applying the model to its particular implementation and/or readying for another iteration.

By recording states on the distributed ledger and related functions, the blockchain network may effectively manage node restarts and dynamic scaling as the number of participant nodes available for participation constantly changes, such as when nodes go on-and-offline, whether because they are turned on/turned off, become connected/disconnected from a network connection, and/or other reasons that node availability can change.

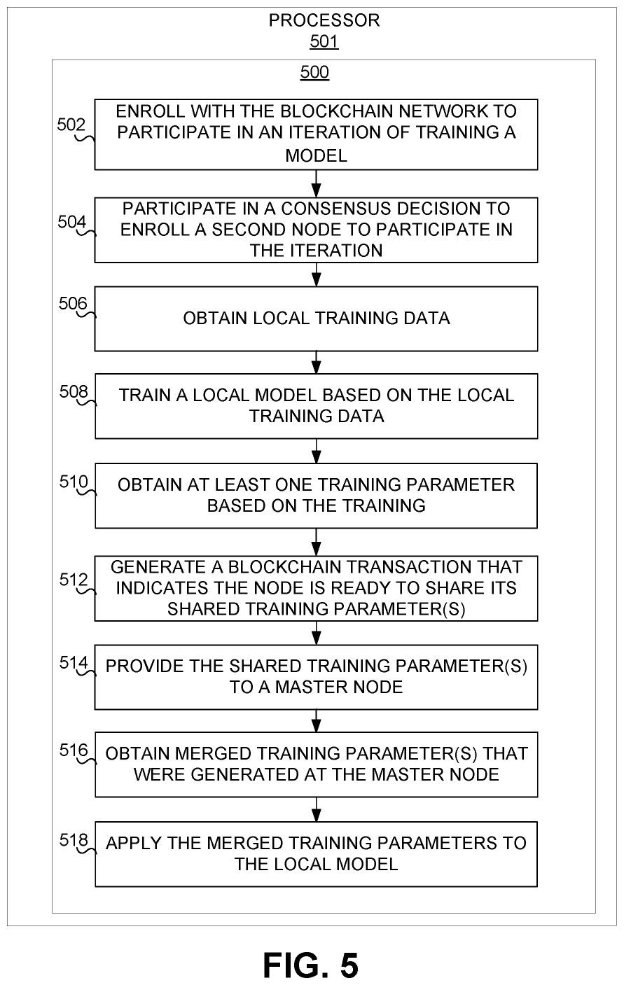

FIG. 5 illustrates an example of a process 500 at a node that participates in an iteration of model building using blockchain, according to an implementation of the invention. Process 500 is illustrated as a series of executable operations performed by processor 501, which can be the processor of node (shown in FIG. 1) acting as a participant node in decentralized model building, as described above. Processor 501 executes the operations of process 500, thereby implementing the disclosed parameter sharing techniques, which realizes precise ML and data privacy preservation.

In an operation 502, the participant node may enroll with the blockchain network to participate in an iteration of model training. At the start of a given iteration, the node may consult a registry structure that specifies a model identifier (representing the model being built), maximum number of iterations for the model, current iteration, minimum number of participants for model building, an array of participant identifiers and majority criterion, and/or other model building information. This structure may be created when the system is set up for decentralized machine learning. Some or all of the parameters of this structure may be stored as a smart contract. The node may first check whether a model identifier exists. If it does not exist it will create new entry in the structure. Due to the serializing property of blockchain transactions, the first node that creates the new entry will win (because no other nodes compete to create entries at this point). If the model identifier does exist, then the node may enroll itself as a participant, and model building may proceed as described herein once the minimum number of participants is achieved.

In an operation 504, the participant node can participate in a consensus decision to enroll a second node that requests to participate in the iteration. The consensus decision may be based on factors such as, for example, one or more of the requesting node's credentials/permission, current state, whether it has stale data, and/or other factors.

In an operation 506, the participant node can obtain local training data. The local training data may be accessible at the participant node, but not accessible to the other participant nodes in the blockchain network. Such local training data may be generated at the participant node (e.g., such as from sensors, actuators, and/or other devices), input at the participant node (e.g., such as from a user), or otherwise be accessible to the participant node. It should be noted that at this point, the participant node will be training on its local training data after it has updated it local training parameters to the most recent merged training parameters from the most recent iteration (the iteration just prior to the current iteration) of model training.

In an operation 508, the participant node can train a local model based on the local training dataset. Such model training may be based on the machine learning framework that is executed on the local training dataset. In some cases, the local training dataset includes data that is subject to privacy restrictions, which limits (or prevents) the accessibility of portions of the local training dataset to other nodes in the blockchain network.

In an operation 510, the participant node can obtain at least one local training parameter. For example, the local training parameter may be an output of model training at the participant node.

In an operation 512, the participant node can generate a blockchain transaction that indicates it is ready to share its local training parameter(s), also referred to herein as shared training parameters. Doing so may broadcast to the rest of the blockchain network that it has completed its local training for the iteration. The participant node may also serialize its training parameter for sharing as shared training parameters.

In an operation 514, the participant node may provide its shared training parameter(s) to a master node, which is elected by the participant node along with one or more other participant nodes in the blockchain network. It should be noted that the participant node may provide its shared training parameter(s) by transmitting them to the master node or otherwise making them available for retrieval by the master node via peer-to-peer connection or other connection protocol.

In an operation 516, the participant node can obtain merged training parameters that were generated at the master node, which generated the merged training parameters based on the shared training parameter(s) provided by the participant node and other participant nodes for the iteration as well.

In an operation 518, the participant node may apply the merged training parameters to the local model and update its state (indicating that the local model has been updated with the current iteration's final training parameters).

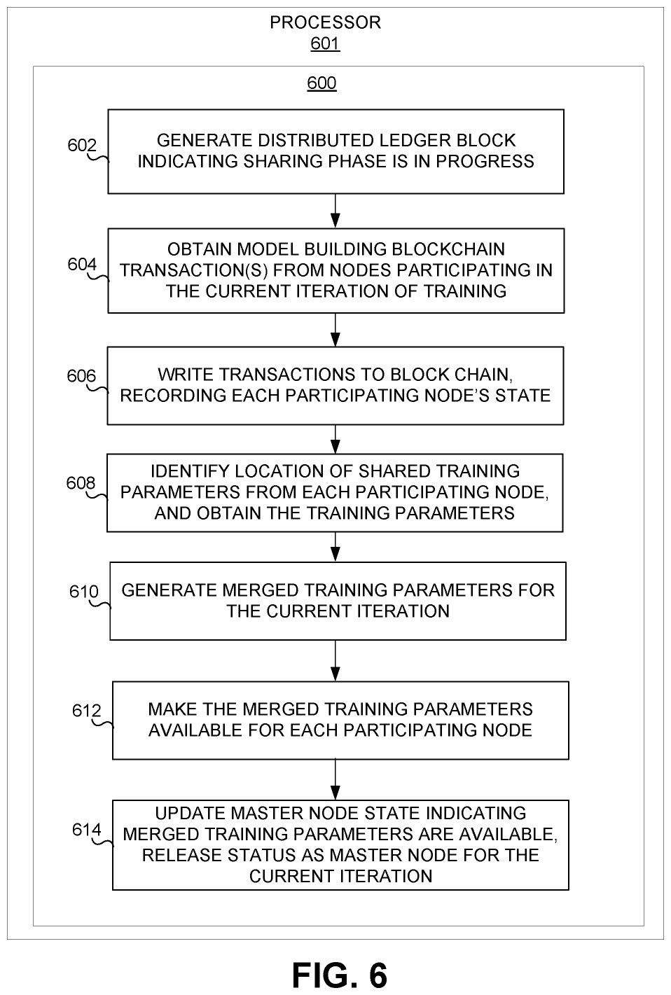

FIG. 6 illustrates an example of a process 600 performed at node acting as a master node in an iteration of model building using blockchain, according to an implementation of the invention. The master node can be elected to generate merged training parameters based on the shared training parameters from participant nodes in the iteration of model building. Process 600 is illustrated as a series of executable operations performed by processor 611, which can be the processor of node (shown in FIG. 1) acting as the master node in decentralized model building, as described above. Processor 601 executes the operations of process 600, thereby implementing the disclosed parameter sharing techniques, which realizes precise ML and data privacy preservation.

In an operation 602, the master node may generate a distributed ledger block that indicates a sharing phase is in progress. For example, the master node may write distributed ledger block that indicates its state. Such state may indicate to participant nodes that the master node is generating final parameters from the training parameters obtained from the participant nodes.

In an operation 604, the master node can obtain blockchain transactions from participant nodes. These transactions may each include indications that a participant node is ready to share its local training parameters, also referred to as the shared training parameters, and/or information indicating how to obtain the shared training parameters.

In an operation 606, the master node may write the transactions to a distributed ledger block and add the block to the distributed ledger.

In an operation 608, the master node may identify a location of shared parameters generated by the participant nodes that submitted the transactions. The master node may obtain these shared training parameters, which collectively represent training parameters from participant nodes that each performed local model training on its respective local training dataset.

In an operation 610, the master node may generate merged training parameters based on the obtained training parameters. For example, the master node may merge the obtained shared training parameters to generate the merged training parameters.

In an operation 612, the master node may make the merged training parameters available to the participant nodes. Each participant node may obtain the merged training parameters to update its local model using the final training parameters.

In an operation 614, the master node may update its state to indicate that the merged training parameters are available. Doing so may also release its status as master node for the iteration and signal that the iteration is complete. In some instances, the master node may monitor whether a specified number of participant nodes and/or other nodes (such as nodes in the blockchain network not participating in the current iteration) have obtained the merged training parameters and release its status as master node only after the specified number and/or percentage has been reached. This number or percentage may be encoded in the smart contracts.

As used herein throughout, the terms “model building” and “model training” are used interchangeably to mean that machine learning on training datasets is performed to generate one or more parameters of a model.

Although illustrated in FIG. 1 as a single component, a node 10 may include a plurality of individual components (e.g., computer devices) each programmed with at least some of the functions described herein. The one or more processors 20 may each include one or more physical processors that are programmed by computer program instructions. The various instructions described herein are provided for illustrative purposes. Other configurations and numbers of instructions may be used, so long as the processor(s) 20 are programmed to perform the functions described herein.

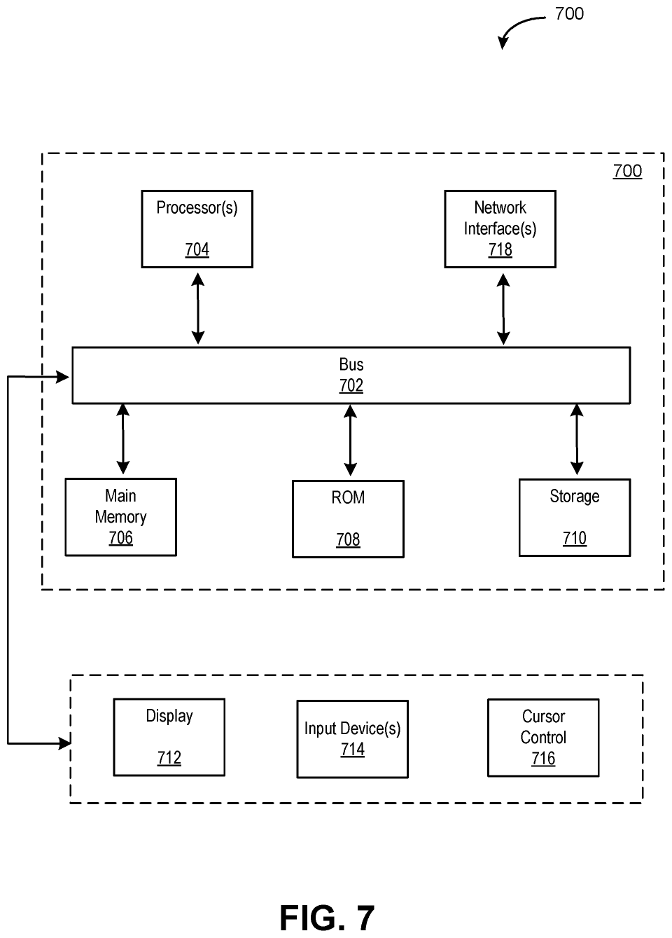

FIG. 7 depicts a block diagram of an example computer system 700 in which the decentralized model building for machine learning (ML) and data privacy preserving using blockchain the embodiments described herein may be implemented. Furthermore, it should be appreciated that although the various instructions are illustrated as being co-located within a single processing unit, such as the node (shown in FIG. 1), in implementations in which processor(s) includes multiple processing units, one or more instructions may be executed remotely from the other instructions.

The computer system 700 includes a bus 702 or other communication mechanism for communicating information, one or more hardware processors 704 coupled with bus 712 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a liquid crystal display (LCD) (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. In some embodiments, the same direction information and command selections as cursor control may be implemented via receiving touches on a touch screen without a cursor.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 716. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

The computer system 700 also includes a communication interface 718 coupled to bus 702. Network interface 718 provides a two-way data communication coupling to one or more network links that are connected to one or more local networks. For example, communication interface 718 may be an integrated services digital network (ISDN) card, cable modem, satellite modem, or a modem to provide a data communication connection to a corresponding type of telephone line. As another example, network interface 718 may be a local area network (LAN) card to provide a data communication connection to a compatible LAN (or WAN component to communicated with a WAN). Wireless links may also be implemented. In any such implementation, network interface 718 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 718, which carry the digital data to and from computer system 710, are example forms of transmission media.

The computer system 700 can send messages and receive data, including program code, through the network(s), network link and communication interface 718. In the Internet example, a server might transmit a requested code for an application program through the Internet, the ISP, the local network and the communication interface 718.

The received code may be executed by processor 704 as it is received, and/or stored in storage device 710, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 700.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system of decentralized machine learning comprising:
a computing node of a blockchain network comprising a plurality of computing nodes having a local training dataset including raw data, wherein the raw data is accessible locally at the computing node, the computing node being programmed to:
train a local model based on the local training dataset during a first iteration of training a machine-learned model;
generate shared training parameters based on the local model;
generate a blockchain transaction comprising an indication that the computing node is ready to share the shared training parameters;
transmit the shared training parameters to a master node that generates a new transaction to be added as a ledger block to each copy of the distributed ledger based on the indication, wherein transmitting the shared training parameters precludes a required accessibility of the raw data at each of the plurality of computing nodes on the blockchain network; and
obtain, from the blockchain network, merged training parameters that were generated by the master node, wherein the merged training parameters are based on a merging of the shared training parameter and additional shared training parameters generated by at least one additional node of the plurality of nodes in the blockchain network; and
apply the merged training parameters to the local model.

2. The system of claim 1, wherein the raw data is subject to privacy restrictions such that the raw data is not accessible to each of the nodes of the plurality of computing nodes.

3. The system of claim 2, wherein the shared training parameters are not subject to the privacy restrictions.

4. The system of claim 3, wherein the shared training parameters are indicative of learning obtained by the computing node during the first iteration of training based on the local training dataset.

5. The system of claim 3, wherein the additional shared training parameters are based on the individualized training of an additional local model by the at least one additional computing node of the plurality of computing nodes during the first iteration of training a machine-learned model and using an additional training dataset that is local to the at least one additional computing node.

6. The system of claim 5, wherein obtaining the merged training parameters precludes a required accessibility of any additional raw data associated with the additional training dataset that is local to the at least one additional computing node.

7. The system of claim 6, wherein the additional raw data is subject to privacy restrictions such that the additional raw data is not accessible to the computing node via the blockchain network.

8. The system of claim 1, wherein to transmit the shared training parameters, the computing node is further programmed to:
serialize the shared training parameters for sharing to the blockchain network;
transmit an indication to at least one other computing node of the plurality of computing nodes on the blockchain network that the computing node is ready to share the shared training parameters.

9. The system of claim 1, further comprising:
a master node selected from among the plurality of computing nodes participating in the first iteration.

10. The system of claim 9, wherein the master node is programmed to:
obtain at least the shared training parameter and the additional shared training parameters;
generate the merged training parameters based on the shared training parameter and the additional shared training parameters;
generate a transaction that includes an indication that the master node has generated the merged training parameters;
cause the transaction to be written as a block on the distributed ledger; and
makes the merged training parameters available to each of the plurality of computing nodes.

11. The system of claim 10, wherein the computing node is further programmed to:
monitor its copy of the distributed ledger; and
determine that the master node has generated the merged parameter based on the generated block in the distributed ledger.

12. The system of claim 9, wherein the computing node is further programmed to:
participate in a consensus decision to elect the master node from among the plurality of computing nodes.

13. A method of decentralized machine learning via a plurality of iterations of training at a computing node of a blockchain network comprising a plurality of computing nodes having a local training dataset including raw data, wherein the raw data is accessible locally at the computing node, the method comprising:
training, by the computing node, a local model based on the local training dataset during a first iteration of training a machine-learned model;
generating, by the computing node, shared training parameters based on the local model;
generating, by the computing node, a blockchain transaction comprising an indication that the computing node is ready to share the shared training parameters;
transmitting, by the computing node, the shared training parameters to a master node, wherein transmitting the shared training parameters precludes a required accessibility of the raw data at each of the plurality of computing nodes on the blockchain network; and
obtaining, by the computing node, merged training parameters, wherein the merged training parameters are based on a merging of the shared training parameter and additional shared training parameters generated by at least one additional node of the plurality of nodes in the blockchain network; and
applying, by the computing node, the merged training parameters to the local model.

14. The method of claim 13, wherein the raw data is subject to privacy restrictions such that the raw data is not accessible to each of the nodes of the plurality of computing nodes.

15. The method of claim 14, wherein the shared training parameters are indicative of learning obtained by the computing node during the first iteration of training based on the local training dataset.

16. The method of claim 15, wherein the additional shared training parameters are based on the individualized training of an additional local model by the at least one additional computing node of the plurality of computing nodes during the first iteration of training a machine-learned model and using an additional training dataset that is local to the at least one additional computing node.

17. The method of claim 16, wherein obtaining the merged training parameters precludes a required accessibility of any additional raw data associated with the additional training dataset that is local to the at least one additional computing node.

18. The method of claim 13, further comprising:
serializing, by the computing node, shared training parameters for sharing to the blockchain network;
transmitting, by the computing node, an indication to at least one other computing nodes of the plurality of computing nodes on the blockchain network that the computing node is ready to share the shared training parameters.

19. A method of coordinating decentralized machine learning via a plurality of iterations of training at a plurality of computing nodes on a blockchain network, each of the plurality of computing nodes having local training datasets including raw data, wherein the raw data is accessible locally at the respective computing node, the method comprising:
obtaining, by a master node, a plurality of shared training parameters, wherein the plurality of shared training parameters are based on the individualized training of local models by each of the computing nodes of the plurality of computing nodes on the blockchain network during a first iteration of training a machine-learned model and using the training dataset that is local respective computing node;
generating, by the master node, merged training parameters based on merging the plurality of shared training parameters;
generating, by the master node, a transaction that includes an indication that the master node has generated the merged training parameters;
causing, by the master node, the transaction to be written as a block on the distributed ledger; and
making, by the master node, the merged training parameters available to each of the plurality of computing nodes on the blockchain network.

20. The method of claim 19, wherein merging is accomplished by at least one of: consensus, majority decision, averaging, or Gaussian merging-splitting.
